(19) United States
(12) Patent Application Publication
(10) Pub. No.: US 2007/0040765 A1
(43) Pub. Date: Feb. 22, 2007

(54) Method for driving display panel

(75) Inventor: Takashi Iwami, Chuo-shi (JP)

Correspondence Address: DRINKER BIDDLE & REATH (DC), 1500 K STREET, N.W., SUITE 1100, WASHINGTON, DC, 20005-1209, US

(73) Assignee: Pioneer Corporation

(21) Appl. No.: 11/350,268

(22) Filed: Feb. 9, 2006

(30) Foreign Application Priority Data
Feb. 10, 2005 (JP) 2005-034078

(51) Int. Cl. G09G 3/28

(52) U.S. Cl. 345/63

(57) ABSTRACT

A driving method for a display panel which has, for each subfield, an address process in which a display data write scan is performed to set pixel cells respectively in a light emitting mode or a non-light emitting mode by scanning the pixel cells for each at least one display line, and a sustain process in which only the pixel cells that are set in the light emitting mode in the address process are caused to emit light. If display data represents same data for a plurality of display lines, the display data write scan is performed simultaneously on the plurality of display lines in the address process.

### BACKGROUND OF THE INVENTION

1. Field of the Invention

The present invention relates to a driving method for driving a display panel such as an alternating current type plasma display panel or an electroluminescence display panel.

2. Description of the Related Background Art

Currently, display panels constituted by a capacitive light-emitting element, such as plasma display panels (abbreviated to PDP hereafter) and electroluminescence display panels (abbreviated to ELP hereafter) are undergoing commercialization as wall-mounted televisions.

FIG. 1 is a view showing the schematic configuration of a plasma display apparatus installed with a PDP as this type of display panel.

In FIG. 1, a PDP 10 serving as a plasma display panel comprises row electrodes Y₁ to Yₙ and X₁ to Xₙ forming X, Y row electrode pairs which correspond to each row (first row to n-th row) of a single screen. The PDP 10 is also formed with column electrodes Z₁ to Zₘ corresponding to each column (first column to m-th column) of the single screen, which are orthogonal to the row electrode pairs and sandwich a dielectric layer, not shown in the drawing, and a discharge space. Note that a pixel cell assuming the role of a pixel is formed at the intersection between each row electrode pair (X, Y) and each column electrode Z.

Each pixel cell emits light through discharge, and therefore possesses only two states, namely a light emitting state at the maximum brightness (luminance), and a non-light emitting state. In other words, as is, each pixel cell is capable of exhibiting only two gradations of brightness, namely the minimum brightness and the maximum brightness.

In order to obtain a midtone brightness level corresponding to an input video signal in the PDP 10 comprising this type of light-emitting element as each pixel cell, a driver 11 implements gradation driving using a subfield method.

In the subfield method, the input video signal is converted into N-bit pixel data corresponding to each pixel, and the display period of a single field is divided into N subfields in accordance with each bit digit of the N-bits. Each subfield is allotted a discharge frequency corresponding to the weighting of the subfield, and discharge is generated selectively only in the subfields corresponding to the video signal. At this time, a midtone brightness level corresponding to the video signal is obtained from the sum total of the discharge frequency of each subfield (within the display period of one field).

A selective erase address method is known as a method of gradationally driving a PDP using this subfield method.

FIG. 2 is a view showing the application timing of various drive pulses that are applied by the driver 11 to the column electrodes and row electrodes of the PDP 10 in one subfield on the basis of the select erase address method.

First, the driver 11 applies a positive reset pulse RP_{Y} to each row electrode Y₁ to Yₙ while simultaneously applying a negative reset pulse RP_{X} to the row electrodes X₁ to Xₙ (in a simultaneous reset process Rc). In response to the application of these reset pulses RPₓ and RP_{y}, all of the pixel cells of the PDP 10 perform reset discharge, whereby a predetermined wall charge is formed uniformly in each pixel cell. As a result, all of the pixel cells are initialized to a light emitting mode.

Next, the driver 11 converts the input video signal into 8-bit pixel data, for example, for each pixel. The driver 11 determines a pixel data bit by dividing the pixel data into bit digits, and generates a pixel data pulse having a pulse voltage corresponding to the logical level of the pixel data bit. For example, the driver 11 generates a pixel data pulse DP having a high voltage when the logical level of the pixel data bit is “1”, and generates a pixel data pulse DP having a low voltage (0 volts) when the logical level is “0”. The driver 11 then applies these pixel data pulses DP to the column electrodes Z₁ to Zₘ sequentially (m times) for each row. In addition, the driver 11 applies a scanning pulse SP such as that shown in FIG. 2 to the row electrodes Y₁ to Yₙ sequentially in synchronization with the application timing of the pixel data pulse DP (in a pixel data write process Wc). In this case, discharge (selective erase discharge) occurs only the pixel cells at the intersections between the row electrodes to which the scanning pulse SP is applied and the column electrodes to which the high-voltage pixel data pulse DP is applied, whereby the wall charge remaining in these pixel cells is erased. Thus, pixel cells initialized to the light emitting mode in the simultaneous reset process Rc are set to the non light-emitting mode. On the other hand, the selective erase discharge described above is not generated in pixel cells applied with both the scanning pulse SP and the low voltage pixel data pulse DP, and therefore these pixel cells are held in the initialized state established in the simultaneous reset process Rc, or in other words in the light emitting mode.

Next, as shown in FIG. 2, the driver 11 applies a positive sustain pulse IP_{X} to the row electrodes X₁ to Xₙ repeatedly, and applies a positive sustain pulse IP_{Y} to the row electrodes Y₁ to Yₙ repeatedly (in a light emission sustain process Ic). In this case, only pixel cells which continue to have a wall charge, or in other words only pixel cells in the light emitting mode, perform discharge (sustain discharge) every time the sustain pulses IP_{X} and IP_{Y} are alternately applied. That is, only pixel cells set to the light emitting mode in the pixel data write process Wc emit light repeatedly by means of sustain discharge performed at a frequency corresponding to the weighting of the corresponding subfield, and sustain this light emitting state. Note that the application frequency of the sustain pulses IP_{X} and IP_{Y} is preset in accordance with the weighting of each subfield.

Next, as shown in FIG. 2, the driver 11 applies an erase pulse EP to the row electrodes X₁ to Xₙ (in an erase process E). As a result, all of the pixel cells are caused to perform an erase discharge at once, whereby the wall charge remaining in each pixel cell is erased.

However, when driving such as that described above is performed on a capacitive display panel such as a PDP or ELP, application of the pixel data pulses DP, for example, causes charge and discharge to be performed on display lines which are not data writing subjects, as well as the display lines which are the data writing subjects. Further, charge or discharge with reference to a capacitance between adjacent column electrodes must also be performed. Hence, a problem arises in that a large amount of power is consumed during pixel data writing.

### SUMMARY OF THE INVENTION

An object of the present invention is to provide a display panel driving method which can achieve reduction in power consumption.

A display panel driving method according to the present invention is a method for dividing each field of an input video signal into a plurality of subfields and driving a display panel for each of the plurality of subfields, so as to perform gradation display, the display panel having a plurality of pixel cells on each display line, wherein the method has, for each of the subfields: an address process in which a display data write scan is performed to set the pixel cells respectively in a light emitting mode or a non-light emitting mode by scanning the pixel cells for each at least one display line in accordance with display data based on the input video signal; and a sustain process in which only the pixel cells that are set in the light emitting mode in the address process are caused to emit light, and wherein if the display data represents same data for a plurality of display lines, the display data write scan is performed simultaneously on the plurality of display lines in the address process.

A display panel driving method according to the present invention is a method for dividing each field of an input video signal into a plurality of subfields and driving a display panel for each of the plurality of subfields, so as to perform gradation display, the display panel having a plurality of pixel cells on each display line, wherein the method has, for each of the subfields: an address process in which a display data write scan by a selective erase address method is performed to set the pixel cells respectively in a light emitting mode or a non-light emitting mode by scanning the pixel cells for each display line in accordance with display data based on the input video signal; and a sustain process in which only the pixel cells that are set in the light emitting mode are caused to emit light, and wherein, in the address process, the display data write scan is executed for display lines in which the display data indicates that a proportion having logical values which are equal to a predetermined value corresponding to the non-light emitting mode for the pixel cells on one display line is large, before the display data write scan is executed for the other display lines in which the display data indicates that the proportion is small.

A display panel driving method according to the present invention is a method for dividing each field of an input video signal into a plurality of subfields and driving a display panel for each of the plurality of subfields, so as to perform gradation display, the display panel having a plurality of pixel cells on each display line, wherein the method has, for each of the subfields: an address process in which a display data write scan by a selective write address method is performed to set the pixel cells respectively in a light emitting mode or a non-light emitting mode by scanning the pixel cells for each display line in accordance with display data based on the input video signal; and a sustain process in which only the pixel cells that are set in the light emitting mode are caused to emit light, and wherein, in the address process, the display data write scan is executed for display lines in which the display data indicates that a proportion having logical values which are equal to a predetermined value corresponding to the light emitting mode for the pixel cells on one display line is large, before the display data write scan is executed for the other display lines in which the display data indicates that the proportion is small.

### BRIEF DESCRIPTION OF THE DRAWINGS

FIG. 1 is a view showing the schematic configuration of a conventional plasma display apparatus;

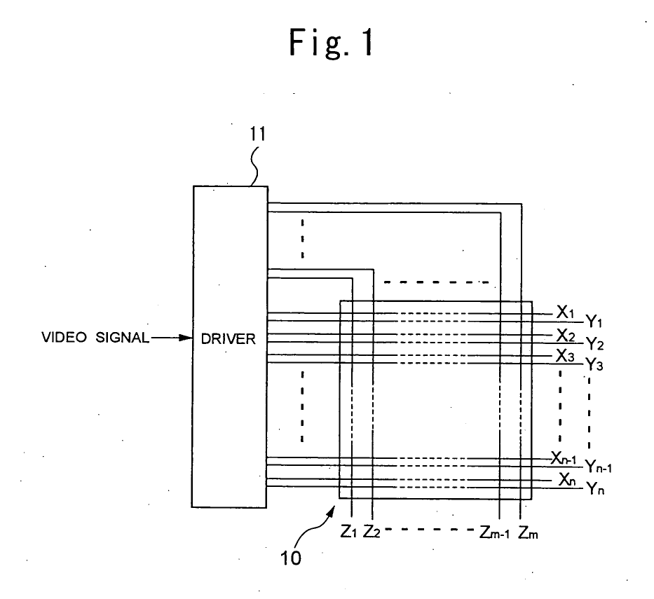

FIG. 2 is a view showing various drive pulses applied to the PDP shown in FIG. 1, and the application timing thereof;

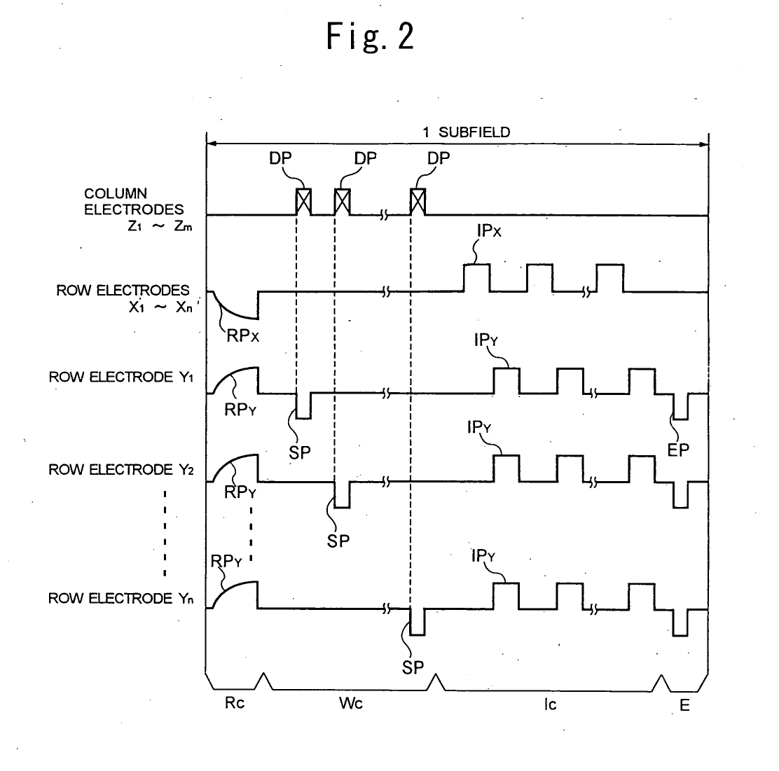

FIG. 3 is a block diagram showing the configuration of a display apparatus to which a driving method according to the present invention is applied;

FIG. 4 is a block diagram showing the configuration of a data conversion circuit in the apparatus of FIG. 3;

FIG. 5 is a view showing an example of a conversion characteristic exhibited by a first data conversion circuit in the circuit of FIG. 4;

FIG. 6 is a view showing a data conversion table of a second data conversion circuit in the circuit of FIG. 4, a light emission drive pattern, and the relationship therebetween;

FIG. 7 is a flowchart illustrating an operation of a display data distribution determination circuit in the apparatus of FIG. 3;

FIG. 8 is a view showing each process of each subfield in a light emission drive sequence performed in the display apparatus of FIG. 3;

FIG. 9 is a flowchart illustrating an operation of a drive control circuit in the apparatus of FIG. 3;

FIG. 10 is a flowchart illustrating in further detail a part of the operation of the drive control circuit in the apparatus of FIG. 3;

FIGS. 11A and 11B are views showing an example of the display data of one subfield in terms of the relationship between a display line and a column electrode in each pixel;

FIG. 12 is a view showing the various drive pulses that are applied to the PDP in a first subfield, and the application timing thereof, in the case of the display data of FIG. 11;

FIGS. 13A and 13B are views showing an example of the display data of one subfield in terms of the relationship between the display line and the column electrode in each pixel; and

FIG. 14 is a view showing an example of the display data of one subfield in terms of the relationship between the display line and the column electrode in each pixel.

### DETAILED DESCRIPTION OF THE INVENTION

An embodiment of the present invention will be described in detail below with reference to the drawings.

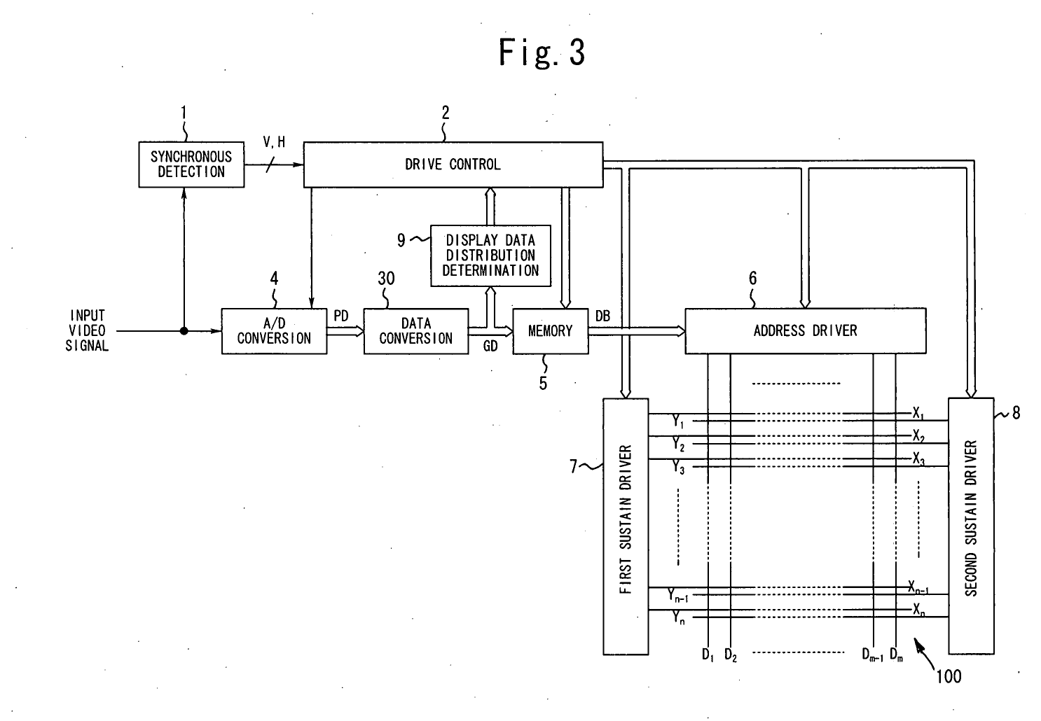

FIG. 3 is a view showing the configuration of a display apparatus for driving a display panel in accordance with the driving method of the present invention.

The display apparatus shown in FIG. 3 is constituted by a plasma display panel 100 (abbreviated to PDP 100 hereafter) serving as a display panel, and a drive unit for driving the PDP 100. The drive unit is constituted by a synchronous detection circuit 1, a drive control circuit 2, an A/D converter 4, a data conversion circuit 30, memory 5, an address driver 6, a first sustain driver 7, a second sustain driver 8, and a display data distribution determination circuit 9.

The PDP 100 comprises m column electrodes D₁ to Dₘ serving as address electrodes, and n row electrodes X₁ to Xₙ and n row electrodes Y₁ to Yₙ arranged orthogonal to the column electrodes. A pixel cell serving as a pixel is formed at the intersection between each column electrode D and a row electrode pair constituted by adjacent row electrodes X and Y. In other words, the PDP 100 is provided with first through n-th display lines (first display line L₁ to an n-th display line Lₙ) on each of which m pixel cells are disposed.

The synchronous detection circuit 1 generates a vertical synchronizing signal V upon detection of a vertical synchronizing signal from an analog input video signal, and generates a horizontal synchronizing signal H upon detection of a horizontal synchronizing signal from the input video signal. The synchronous detection circuit 1 then supplies the drive control circuit 2 with these signals V, H. The A/D converter 4 samples the input video signal in response to a clock signal supplied by the drive control circuit 2, converts the sampled input video signal into 8-bit pixel data PD for each pixel, for example, and supplies the data conversion circuit 30 with the pixel data PD. In other words, the pixel data PD express the brightness level of each pixel indicated by the input video signal as a value between “0” and “255”.

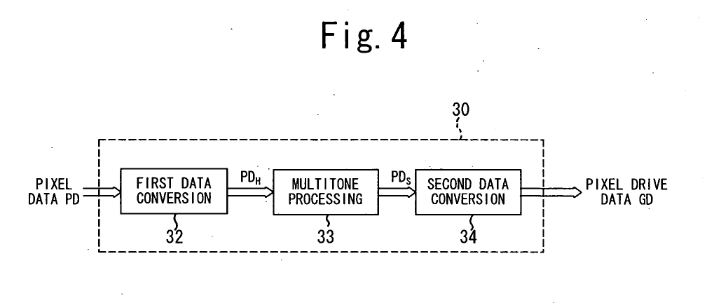

FIG. 4 is a view showing the internal configuration of the data conversion circuit 30.

As shown in FIG. 4, the data conversion circuit 30 is constituted by a first data conversion circuit 32, a multitone (multi-gradation) processing circuit 33, and a second data conversion circuit 34.

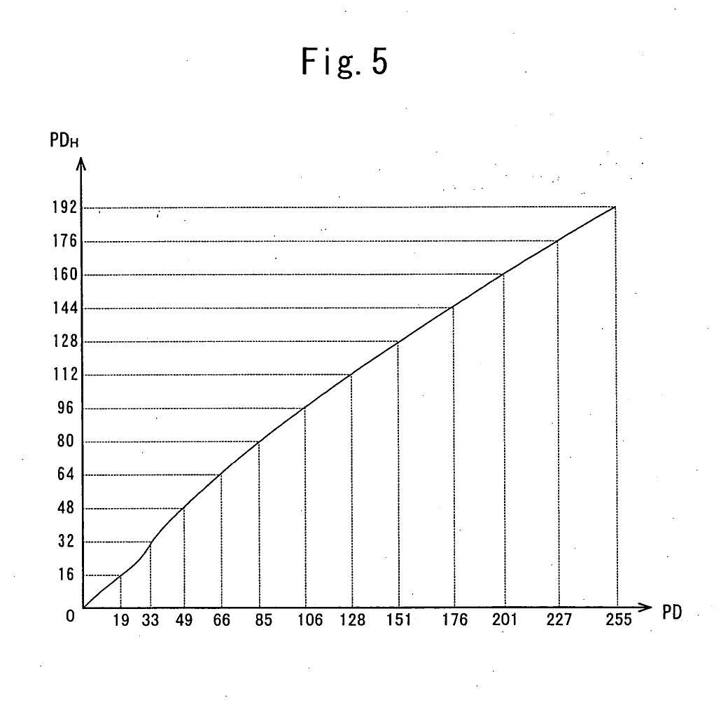

In FIG. 4, the first data conversion circuit 32 converts the brightness level of each pixel, indicated by the 8-bit pixel data PD, into brightness controlled pixel data PD_{L}, which expresses in 8 bits a brightness level from “0” to “192”, in accordance with a conversion characteristic shown in FIG. 5, and supplies the multitone processing circuit 33 with the brightness controlled pixel data PD_{L}. This data conversion performed by the first data conversion circuit 32 suppresses the occurrence of brightness saturation due to the multitone processing performed by the multitone processing circuit 33 and flat parts which appear in the display characteristic when a display gradation is not at a bit boundary (i.e. the occurrence of gradation distortion).

The multitone processing circuit 33 performs error dispersion processing and dither processing on the 8-bit brightness controlled pixel data PD_{L}, and thereby generates multitone pixel data PD_{S} in which the number of bits is reduced to 4 while the current number of tones is maintained. The multitone processing circuit 33 then supplies the second data conversion circuit 34 with the multitone pixel data PD_{S}. In the error dispersion processing, for example, first the upper six bits of the pixel data PD are treated as main data, while the remaining lower two bits are treated as error data. A value obtained by performing weighted addition on the error data of the pixel data PD, corresponding to each peripheral pixel, is reflected in the main data. By means of this operation, the brightness of the lower two bits of the original pixel is artificially represented by the peripheral pixels. Therefore, it becomes possible to display brightness tones equal to the 8-bit pixel data using the six bit main data, i.e. data that are smaller than 8 bits. Dither processing is then implemented on the 6-bit error dispersion processed pixel data obtained as a result of the error dispersion processing. In the dither processing, a plurality of adjacent pixels are set as a single pixel unit, and dither added pixel data are obtained by allocating and adding dither coefficients constituted by varying coefficient values respectively to the error dispersion processed pixel data corresponding to each pixel in the single pixel unit. When considered in terms of the single pixel unit, by adding dither coefficients in this manner, brightness corresponding to eight bits can be expressed even with only the upper four bits of the dither added pixel data. The multitone processing circuit 33 then supplies the second data conversion circuit 34 with the upper four bits of the dither added pixel data as the multitone pixel data PD_{S}.

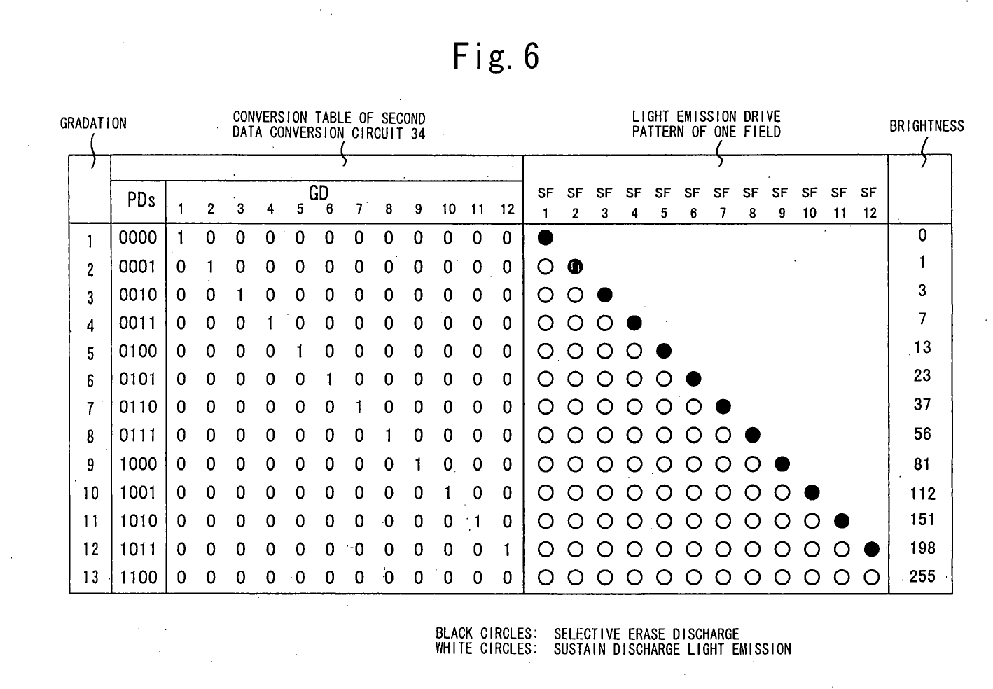

The second data conversion circuit 34 converts the 4-bit multitone pixel data PD_{S} into pixel drive data GD constituted by first through twelfth bits in accordance with a conversion table shown in FIG. 6, and supplies the memory 5 and the display data distribution determination circuit 9 with the pixel drive data GD.

The memory 5 writes the pixel drive data GD sequentially in accordance with a write signal supplied by the drive control circuit 2. By means of this write operation, when the writing of the pixel drive data GD_{(1, 1)} to GD_{(n, m)} for one screen (n rows, m columns) is complete, the memory 5 performs the following read operation in accordance with a read signal supplied by the drive control circuit 2. First, the memory 5 reads only the first bit of each set of pixel drive data GD_{(1, 1)} to GD_{(n, m)} as a pixel drive data bit DB1, and supplies these bits to the address driver 6 one display line at a time. Next, the memory 5 reads only the second bit of each set of pixel drive data GD_{(1, 1)} to GD_{(n, m)} as a pixel drive data bit DB2, and supplies these bits to the address driver 6 one display line at a time. Next, the memory 5 reads only the third bit of each set of pixel drive data GD_{(1, 1)} to GD_{(n, m)} as a pixel drive data bit DB3, and supplies these bits to the address driver 6 one display line at a time. In the same manner, the memory 5 reads the fourth through twelfth bits of each set of pixel drive data GD_{(1, 1)} to GD_{(n, m)} as pixel drive data bits DB4 to DB12, and supplies these bits to the address driver 6 one display line at a time.

The memory 5 performs this read operation on each of the pixel drive data bits DB1 to DB12 at a timing matched to each of subfields SF1 to SF12 to be described below. In other words, the memory 5 reads the pixel drive data bit DB1 in the subfield SF1, and reads the pixel drive data bit DB2 in the subfield SF2.

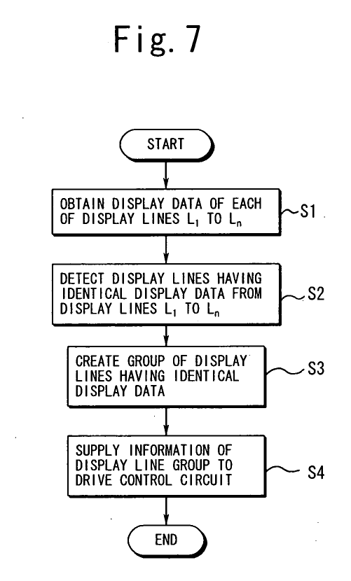

As shown in FIG. 7, the display data distribution determination circuit 9 obtains display data for each of the first display line L₁ to an n-th display line Lₙ in each subfield in accordance with the pixel drive data GD (step S1). The display data for each of the first display line L₁ to the n-th display line Lₙ may be created in the display data distribution determination circuit 9 or obtained from the memory 5. The display data for one display line is indicated by logical values LV₁ to LVₘ for m pixels. The display data distribution determination circuit 9 detects the identical display data in the first display line L₁ through the n-th display line Lₙ, or in other words display lines each corresponding to the logical values LV₁ to LVₘ (step S2), and creates a group of display lines having the identical display data (step S3). Information relating to the display line group is then supplied to the drive control circuit 2 for each subfield (step S4).

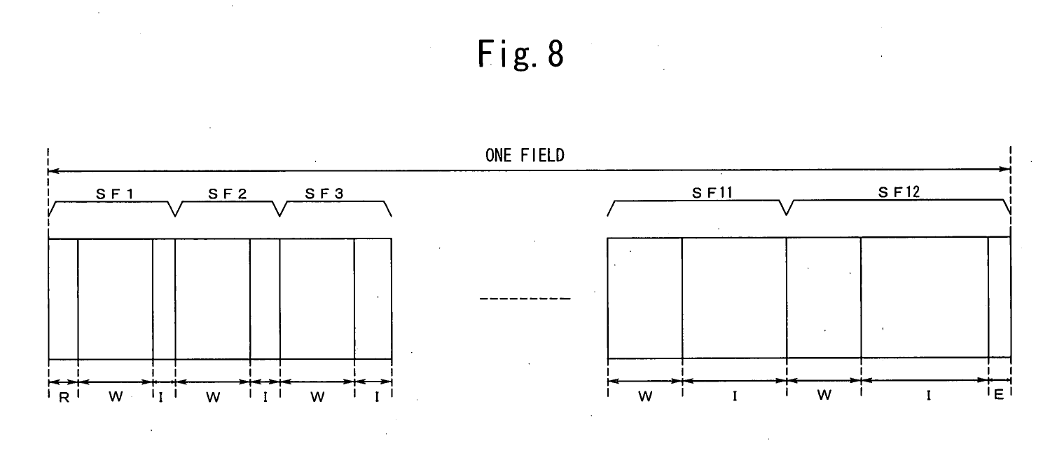

In accordance with a light emission drive sequence based on the subfield method, which is shown in FIG. 8, the drive control circuit 2 supplies various timing signals for driving the PDP 100 to the address driver 6, first sustain driver 7, and second sustain driver 8.

In the light emission drive sequence shown in FIG. 8, an address process W for setting each pixel cell in the light emitting mode or the non-light emitting mode is executed in each of the twelve subfields SF1 to SF12 in accordance with the pixel drive data bits DB. A sustain process I is also executed in each of the subfields SF1 to SF12 for causing only the pixel cells set in the light emitting mode to emit light continuously during a period corresponding to the weighting of the corresponding subfield. For example, assuming that the light emitting period in the sustain process I executed in the subfield SF1 is “1”, the pixel cells that are set in the light emitting mode are caused to emit light continuously during the following periods to in the sustain process I of each subfield SF1 to SF12:

SF1: 1, SF2: 2, SF3: 4, SF4: 6, SF5: 10, SF6: 14, SF7: 19, SF8: 25, SF9: 31, SF10: 39, SF11: 47, and SF12: 57.

In the first subfield SF1, a reset process R is executed prior to the address process to initialize all of the pixel cells to the light emitting mode. In the final subfield SF12, an erase process E is executed after the sustain process I to shift all of the pixel cells to the non-light emitting mode.

In the address process W of each subfield SF1 to SF12, each of the pixel cells belonging to each of the first through n-th display lines of the PDP 100 are set in the following manner to the light emitting mode or the non-light emitting mode sequentially for each display line group or one display line.

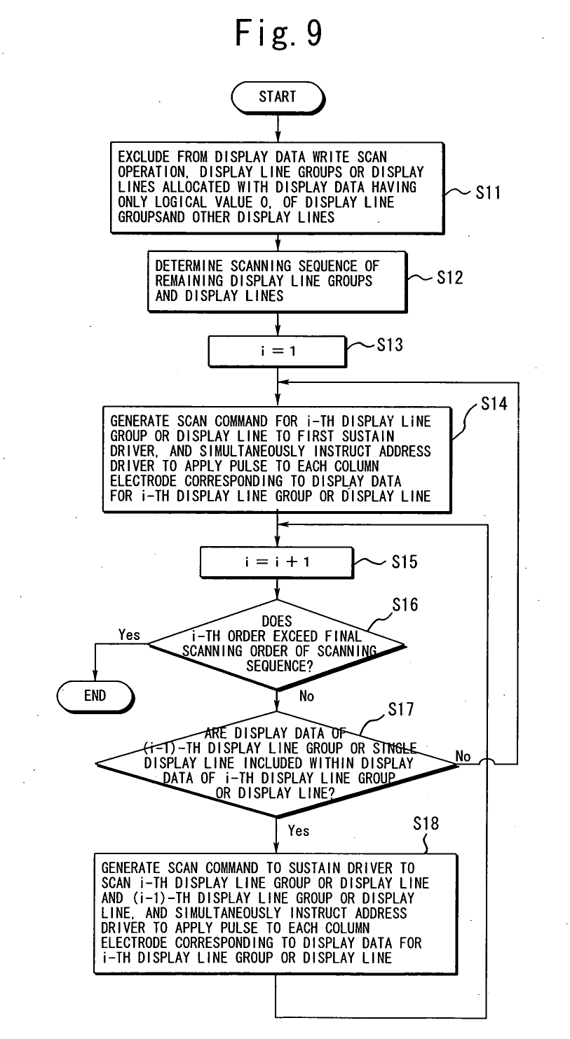

As shown in FIG. 9, the drive control circuit 2 excludes from a display data write scan operation, display line groups or display lines to which display data having only logical values of “0” is allocated, of the display line groups and other display lines, for each subfield (step S11). The display line groups serve as the determination information of the display data distribution determination circuit 9. A scanning sequence is then determined for the remaining display line groups and other display lines extracted in the step S11 (step S12). The scanning sequence is an order of the remaining display line groups and display lines, which is begun from the display line group or display line allocated with the largest proportion of display data having a logical value “1”. First, the i-th order of the determined scanning sequence is set as the first order (step S13). A scan command to scan the i-th display line group or individual display line is then issued to the first sustain driver 7, and simultaneously, the address driver 6 is instructed to perform pulse application on each of the column electrodes D₁ to Dₘ corresponding to the display data of the i-th display line group or individual display line (step S14).

Next, one is added to i (step S15), and a determination is made as to whether or not the i-th order exceeds the final scanning order of the determined scanning sequence (step S16). When the i-th order is equal to or lower than the final scanning order, a determination is made as to whether or not the display data of the (i-1)-th display line group or individual display line are included within the display data of the i-th display line group or individual display line (step S17). In other words, a determination is made as to whether or not the logical value “1” portions of the display data LVₗᵢ to LVₘᵢ of the i-th display line group or individual display line takes the logical value “1” portions even in the display data LV₁ᵢ₋₁ to LVₘᵢ₋₁ of the (i-1)-th display line group or individual display line. For example, when only LV₁ᵢ, LV₃ᵢ, LV₆ᵢ, and LVₘᵢ of the display data of the i-th display line group have the logical value “1” and LV₁ᵢ₋₁, LV₃ᵢ₋₁, LV₆ᵢ₋₁, and LVₘᵢ₋₁ of the display data of the (i-1)-th display line group also have the logical value “1”, this indicates that the display data of the i-th display line group are included in the display data of the (i-1)-th display line group. When this situation arises, a scan command is issued to the first sustain driver 7 to scan the i-th display line group or individual display line and the (i-1)-th display line group or individual display line, and simultaneously, the address driver 6 is instructed to perform pulse application on each of the column electrodes D₁ to Dₘ corresponding to the display data of the i-th display line group or individual display line (step S18). When the determination result of the step S17 is negative, the process advances to the step S14, where a scan command and pulse application command are issued.

When it is determined in the step S16 that the i-th order exceeds the final scanning order, the address process W of the current subfield ends.

In the address process W, the first sustain driver 7 applies a scanning pulse SP to the row electrodes of the display line group or individual display line for which the scan command is issued. Further, in response to the pulse application command and in synchronization with the scanning pulse SP application timing, the address driver 6 generates m pixel data pulses individually, these pulses corresponding to the display data LV₁ᵢ to LVₘᵢ of the i-th display line group or individual display line, and applies the pulses simultaneously to the column electrodes D₁ to Dₘ. LV₁ᵢ corresponds to the column electrode D₁, LV₂ᵢ corresponds to the column electrode D₂, . . . , and LVₘᵢ corresponds to the column electrode Dₘ. If the logical value of LV₁ᵢ is “0”, a low voltage (0 volts) pixel data pulse is generated, and if the logical value of LV₁ᵢ is “1”, a high voltage pixel data pulse is generated. The low voltage or high voltage pixel data pulses are generated similarly for each of LV₂ᵢ to LVₘᵢ.

If the i-th order of the determined scanning sequence is an individual display line, the scanning pulse SP is applied to the row electrode Y of the display line, discharge (selective erase discharge) is performed in only the pixel cells at the intersections between the row electrode and column electrodes to which the high voltage pixel data pulse is applied, and thus the remaining wall charge in each of the pixel cells is erased. When the i-th order of the determined scanning sequence is a display line group, the scanning pulse SP is applied simultaneously to the row electrodes Y of the plurality of display lines belonging to the display line group, discharge (selective erase discharge) is performed in only the pixel cells at the intersections between the row electrodes Y and column electrodes to which the high voltage pixel data pulses are applied respectively, and thus the remaining wall charge in each of the pixel cells is erased. The pixel cells subjected to this selective erase discharge shift to a state (referred to as the non-light emitting mode hereafter) in which sustain discharge is not performed in the sustain process I to be described below. On the other hand, the pixel cells which do not perform selective erase discharge maintain their immediately preceding state. In other words, pixel cells that have been in the light emitting mode remain in the light emitting mode, while pixel cells that have been in the non-light emitting mode are sustained in the non-light emitting mode.

Further, when the display data of the (i-1)-th display line group are included within the display data of the i-th individual display line, the scanning pulse SP is applied to the row electrode of the i-th individual display line and the row electrode of each of the plurality of display lines belonging to the (i-1)-th display line group, at the same time, whereby the selective erase discharge is generated in only the pixel cells at the intersections between the row electrodes and the column electrodes to which the high voltage pixel data pulses are applied respectively. This is performed in consideration of the case in which the selective erase discharge is not generated during the preceding ((i-1)-th) scan for the pixel cells on the plurality of display lines belonging to the (i-1)-th display line group of the scanning sequence, which are to be set in the non-light emitting mode in the current subfield, in order to generate selective erase discharge in each pixel cell allocated with the logical value “1” in duplicate, of the pixel cells to be set in the non-light emitting mode, so that these pixel cells can be set in the non-light emitting mode reliably during the i-th scan.

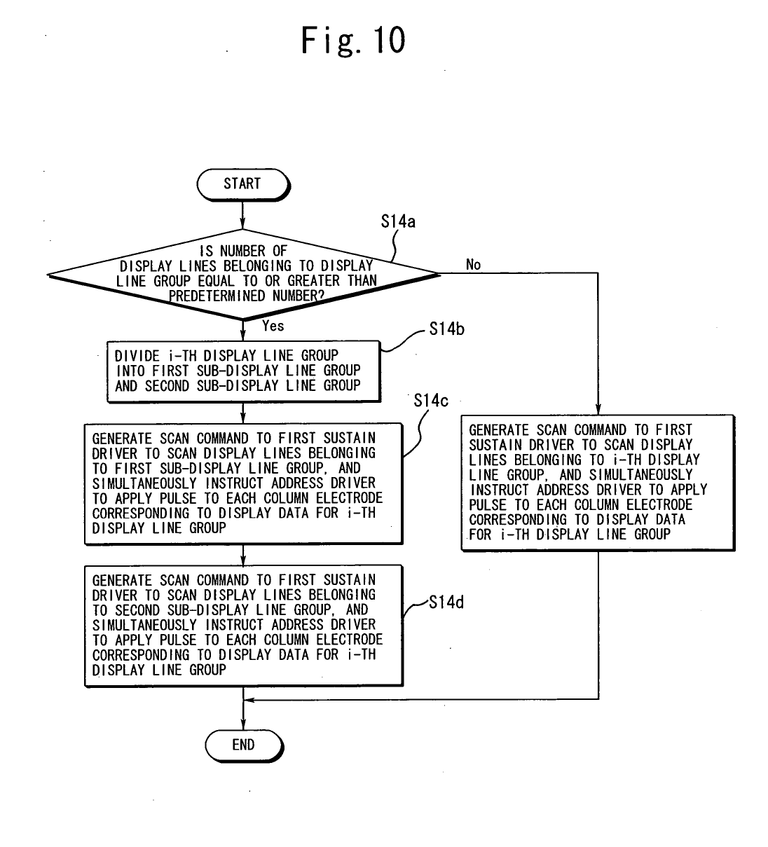

Note that when the number of display lines belonging to a display line group for each of the display line groups is equal to or greater than a predetermined number in the step S14 or S18, the display line group may be divided into a plurality of sub-display line groups to perform the display data write scanning, individually. For example, as shown in FIG. 10, a determination is made in relation to each of the display line groups as to whether or not the number of display lines belonging to each display line group is equal to or greater than a predetermined number (step S14a), and upon detection of a display line group having a number of display lines that is equal to or greater than the predetermined number, the display line group is divided into a first sub-display line group and a second sub-display line group (step S14b). A scan command to scan the display lines belonging to the first sub-display line group is issued to the first sustain driver 7, and simultaneously, the address driver 6 is instructed to perform pulse application onto each of the column electrodes D₁ to Dₘ corresponding to the display data of the i-th display line group (step S14c). A scan command to scan the display lines belonging to the second sub-display line group is issued to the first sustain driver 7, and simultaneously, the address driver 6 is instructed to perform pulse application on each of the column electrodes D₁ to Dₘ corresponding to the display data of the i-th display line group (step S14d). Also in the step S14c, a scan command is issued to the first sustain driver 7 to scan the display line groups or individual display lines in which the number of display lines is less than the predetermined number, and simultaneously, the address driver 6 is instructed to perform pulse application onto each of the column electrodes D₁ to Dₘ corresponding to the display data of the i-th display line group or individual display line.

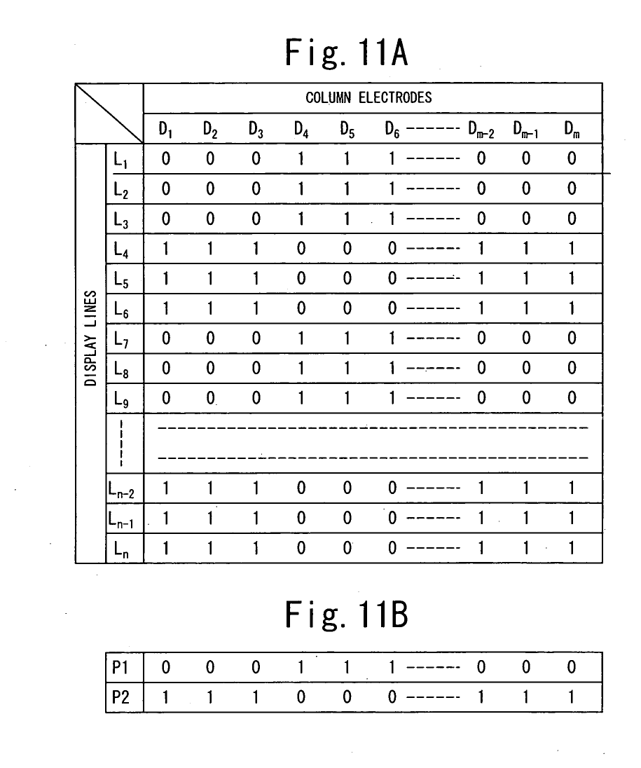

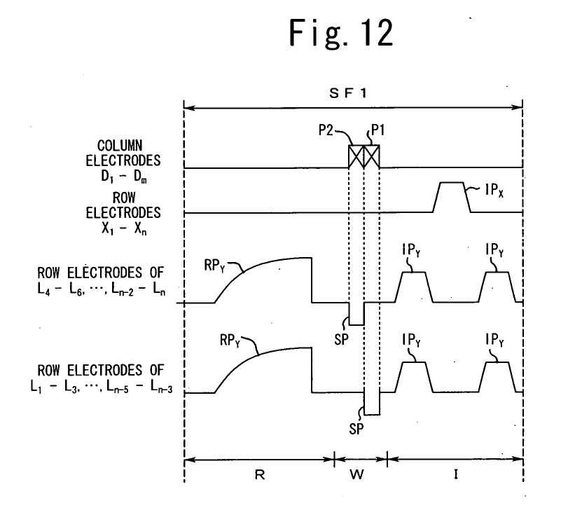

FIG. 11A shows display data of one subfield in a checkered pattern, in terms of the relationships between the display lines L₁ to Lₙ and the column electrodes D₁ to Dₘ for all the pixel cells. The display data are divided into two patterns, P1 and P2, as shown in FIG. 11B. Accordingly, a pattern P1 display line group and a pattern P2 display line group are created in the display data distribution determination circuit 9. The display data of the pattern P2 contains the number of logical values of “1” larger than the pattern P1, and therefore in the address process of a subfield which uses the P1 and P2 display data, as shown in FIG. 12, first, the high voltage pixel data pulses are applied to the column electrodes D₁ to D₃, . . . , Dₘ₋₂ to Dₘ at the application timing of the scanning pulse SP to the row electrodes of the display lines L₄ to L₆, . . . , Lₙ₋₂ to Lₙ belonging to the pattern P2 display line group, whereby the selective erase discharge is performed in each of the pixel cells at the intersections between these row electrodes and column electrodes. Then, the high voltage pixel data pulses are applied to the column electrodes D₄ to D₆, . . . , Dₘ₋₅ to Dₘ₋₃ at the application timing of the scanning pulse SP to the row electrodes of the display lines L₁ to L₃, L₇ to L₉, . . . , Lₙ₋₅ to Lₙ₋₃ belonging to the pattern P1 display line group, whereby the selective erase discharge is performed in each of the pixel cells at the intersections between these row electrodes and column electrodes. By performing this address operation, the time required for the address process can be shortened.

In the display data shown in FIG. 11A, when the number of display lines in each of the pattern P1 display line group and the pattern P2 display line group is equal to or greater than a predetermined number, display data write scanning, or an address operation is performed sequentially on a first display line group L₄ to L₆, L₁₆ to L₁₈, . . . of the pattern P2, a second display line group L₁₀ to L₁₂, L₂₂ to L₂₄, . . . of the pattern P2, a first display line group L₁ to L₃, L₁₃ to L₁₅, . . . of the pattern P1, and a second display line group L₇ to L₉, L₁₉ to L₂₁, . . . of the pattern P1.

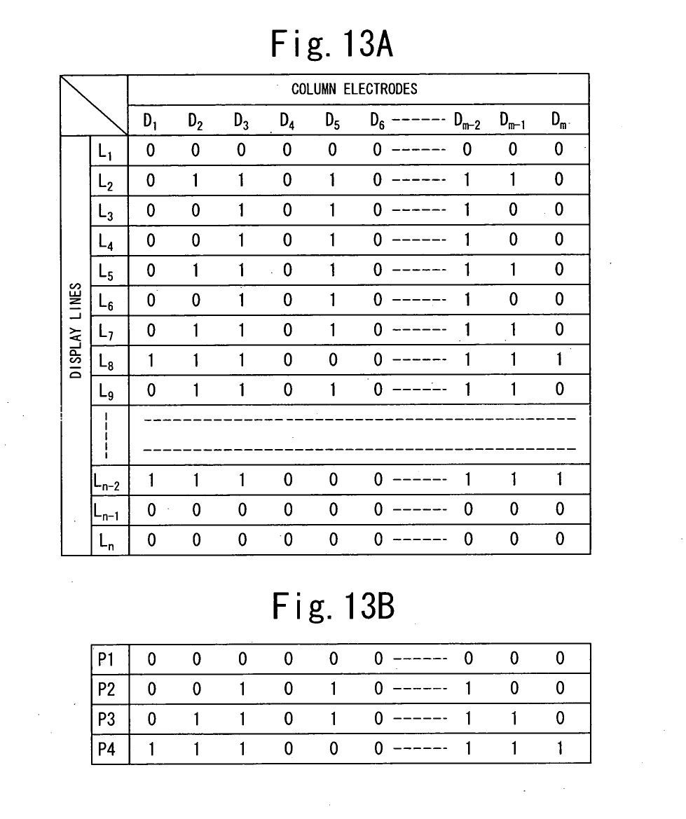

FIG. 13A shows display data of one subfield in a different display from that shown in FIG. 11A, in terms of the relationships between the display lines L₁ to Lₙ and the column electrodes D₁ to Dₘ for all the pixel cells. As shown in FIG. 13B, the display data are divided into four patterns P1 to P4. Assume that in the number of logical values of “1” included in each of the patterns P4, P3, P2, and P1, there is a relation of P4>P3>P2>P1. In the address process of a subfield which uses the display data of P1 through P4, no scanning pulse SP is applied to the display lines L₁, . . . , Lₙ₋₁ , Lₙ belonging to the pattern P1 display line group since the display data of the pattern P1 all have the logical value “0”. In other words, the address operation is ignored, and in the current subfield, the pixel cells at the intersections between the row electrodes of the display lines and the column electrodes D₁ to Dₘ are sustained in the light emitting mode. Then, the high voltage pixel data pulses are applied to the column electrodes D₁ to D₃, . . . , Dₘ₋₂ to Dₘ at the application timing of the scanning pulse SP to the row electrodes of the display lines L₈, . . . , Lₙ₋₂ belonging to the pattern P4 display line group, whereby the selective erase discharge is performed in each of the pixel cells at the intersections between these row electrodes and column electrodes. Next, the scanning pulse SP is applied to the row electrodes of the display lines L₈, . . . , Lₙ₋₂ belonging to the pattern P4 display line group at the application timing of the scanning pulse SP to the row electrodes of the display lines L₂, L₅, L₇, L₉, . . . belonging to the pattern P3 display line group, and simultaneously, the high voltage pixel data pulses are applied to the column electrodes D₂, D₃, D₅, . . . , Dₘ₋₂, Dₘ₋₁, whereby the selective erase discharge is performed in each of the pixel cells at the intersections between these row electrodes and column electrodes. Then, at the application timing of the scanning pulse SP to the row electrodes of the display lines L₃, L₄, L₆, . . . belonging to the pattern P2 display line group, the scanning pulse SP is applied to the row electrodes of the display lines L₂, L₅, L₇, L₉, . . . belonging to the pattern P3 display line group, and simultaneously, the high voltage pixel data pulses are applied to the column electrodes D₃, D₅, . . . , Dₘ₋₂, whereby the selective erase discharge is performed in each of the pixel cells at the intersections between these row electrodes and column electrodes. Thus, the display data write operation is performed continuously for the pixel cells having the logical value “1” in duplicate between the patterns P4, P3 and the patterns P3, P2, enabling a reduction in the time required for the address process and an improvement in the selection margin.

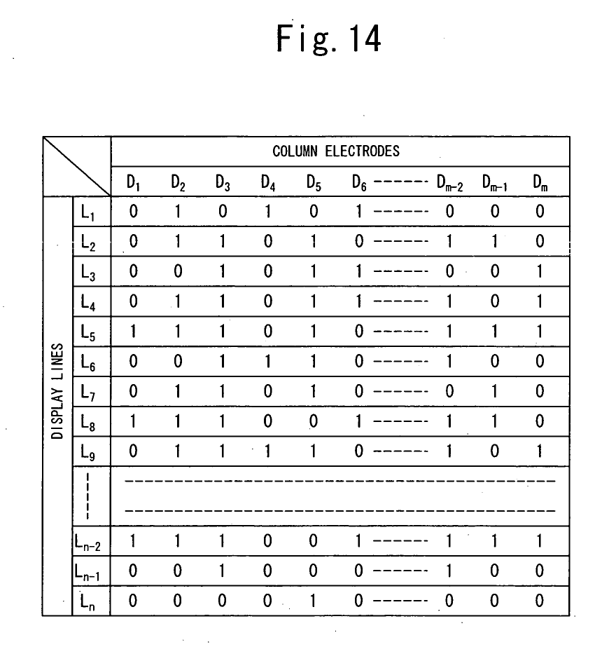

FIG. 14 shows the display data of one subfield in the case where the data content differs on each display line, in terms of the relationship between the display line L₁ to Lₙ and the column electrode D₁ to Dₘ in each pixel. With this type of display data, the display data write operation is performed in order from the display line allocated with the display data having a great number of logical values of “1”. Similarly in this case, the display data write operation is performed continuously on pixel cells having the logical value “1” in duplicate between two adjacent lines in the scanning sequence while a large number of priming particles exists, and therefore the selection margin is improved.

In the sustain process I of each subfield, the first sustain driver 7 and second sustain driver 8 apply the positive sustain pulses IP_{X} and IP_{Y} alternately and repeatedly to the row electrodes X₁ to Xₙ and Y₁ to Yₙ, as shown in FIG. 12. In this case, the application frequency of the individual sustain pulses IP_{X} and IP_{Y} in the sustain process I of each subfield SF1 to SF12 corresponds to the light emission period allocated to each subfield, as described above.

At this time, only pixel cells having a remaining wall charge, or in other words only the pixel cells that remain in the light emitting mode, perform a sustain discharge every time the sustain pulses IP_{X} and IP_{Y} are applied. As a result, the pixel cells that are in the light emitting mode sustain the light emitting state which accompanies the sustain discharge during the light emission period allocated to each subfield.

In the erase process E implemented in the final subfield SF12 alone, the address driver 6 generates a positive erase pulse AP and applies the pulse AP to the column electrodes D₁ to Dₘ. Further, the second sustain driver 8 generates a negative erase pulse EP at the application timing of the erase pulse AP, and applies the pulse EP to each of the row electrodes Y₁ to Yₙ. By applying these erase pulses AP and EP simultaneously, erase discharge is performed in all of the pixel cells of the PDP 100, and thus the remaining wall charge in all of the pixel cells is erased.

Only the pixel cells that are set to the light emitting mode in the address process W of each subfield perform light emission repeatedly through sustain discharge in the immediately following sustain process I.

In the embodiments described above, one field is constituted by N, for example 12, subfields, and the present invention is applied to a sequence in which N+1 gradation display is performed. However, the present invention may be applied to any of a sequence in which 2N gradation display is performed, a selective write address method, and a selective erase address method.

In the embodiments described above, since the address process of the selective erase address method is represented, the display data write scan is executed for the display lines of the display panel except display lines in which the display data relating to all the pixel cells has only a logical value “0” corresponding to the light emitting mode. When the present invention is applied to the selective write address method, in the address process, the display data write scan may be executed for the display lines of the display panel except display lines in which the display data relating to all the pixel cells has only a logical value “1” corresponding to the non-light emitting mode.

Further, in the embodiments described above, in the address process of the selective erase address method, the display data write scan is executed for display lines in which the display data indicates that a proportion having logical values of “0” corresponding to the non-light emitting mode for the pixel cells on one display line is large, before the display data write scan is executed for the other display lines in which the display data indicates that the proportion is small. When the present invention is applied to the selective write address method, in the address process, the display data write scan may be executed for display lines in which the display data indicates that a proportion having logical values of “1” corresponding to the light emitting mode for the pixel cells on one display line is large, before the display data write scan is executed for the other display lines in which the display data indicates that the proportion is small.

According to the present invention as described above, the number of display data write scans in each subfield of an address process is reduced, and therefore, reduction in power consumption can be achieved.

This application is based on Japanese Patent Application No. 2005-340785 which is hereby incorporated by reference.

What is claimed is:

1. A driving method for dividing each field of an input video signal into a plurality of subfields and driving a display panel for each of the plurality of subfields, so as to perform gradation display, said display panel having a plurality of pixel cells on each display line,
wherein said method has, for each of said subfields:
an address process in which a display data write scan is performed to set said pixel cells respectively in a light emitting mode or a non-light emitting mode by scanning said pixel cells for each at least one display line in accordance with display data based on the input video signal; and
a sustain process in which only said pixel cells that are set in the light emitting mode in the address process are caused to emit light, and
wherein if the display data represents same data for a plurality of display lines, said display data write scan is performed simultaneously on the plurality of display lines in the address process.

2. The driving method according to claim 1, wherein, in the address process of a selective erase address method, the display data write scan is executed for the display lines of the display panel except display lines in which the display data relating to all the pixel cells has only a logical value equal to a predetermined value corresponding to the light emitting mode.

3. The driving method according to claim 1, wherein, in the address process of a selective write address method, the display data write scan is executed for the display lines of the display panel except display lines in which the display data relating to all the pixel cells has only a logical value equal to a predetermined value corresponding to the non-light emitting mode.

4. The driving method according to claim 1, wherein, in the address process of a selective erase address method, the display data write scan is executed for display lines in which the display data indicates that a proportion having logical values which are equal to a predetermined value corresponding to the non-light emitting mode for said pixel cells on one display line is large, before the display data write scan is executed for the other display lines in which the display data indicates that the proportion is small.

5. The driving method according to claim 1, wherein, in the address process of a selective write address method, the display data write scan is executed for display lines in which the display data indicates that a proportion having logical values which are equal to a predetermined value corresponding to the light emitting mode for said pixel cells on one display line is large, before the display data write scan is executed for the other display lines in which the display data indicates that the proportion is small.

6. The driving method according to claim 1, wherein, when the number of display lines belonging to a display line group having same display data in each display line is equal to or greater than a predetermined number, the display lines in said display line group are divided into a plurality of sub-display line groups in said address process, and the display data write scan is performed for each of the plurality of sub-display line groups.

7. The driving method according to claim 4, wherein, in write scanning of a second display line having a logical value pattern of a second display data which is included within a logical value pattern of a first display data for a first display line which completes the display data write scan prior to said second display line in said address process, said first display line is scanned simultaneously.

8. A driving method for dividing each field of an input video signal into a plurality of subfields and driving a display panel for each of the plurality of subfields, so as to perform gradation display, said display panel having a plurality of pixel cells on each display line,
wherein the method has, for each of said subfields:
an address process in which a display data write scan by a selective erase address method is performed to set said pixel cells respectively in a light emitting mode or a non-light emitting mode by scanning said pixel cells for each display line in accordance with display data based on the input video signal; and
a sustain process in which only said pixel cells that are set in said light emitting mode are caused to emit light, and
wherein, in the address process, the display data write scan is executed for display lines in which the display data indicates that a proportion having logical values which are equal to a predetermined value corresponding to the non-light emitting mode for said pixel cells on one display line is large, before the display data write scan is executed for the other display lines in which the display data indicates that the proportion is small.

9. A driving method for dividing each field of an input video signal into a plurality of subfields and driving a display panel for each of the plurality of subfields, so as to perform gradation display, said display panel having a plurality of pixel cells on each display line,
wherein the method has, for each of said subfields:
an address process in which a display data write scan by a selective write address method is performed to set said pixel cells respectively in a light emitting mode or a non-light emitting mode by scanning said pixel cells for each display line in accordance with display data based on the input video signal; and
a sustain process in which only said pixel cells that are set in said light emitting mode are caused to emit light, and
wherein, in the address process, the display data write scan is executed for display lines in which the display data indicates that a proportion having logical values which are equal to a predetermined value corresponding to the light emitting mode for said pixel cells on one display line is large, before the display data write scan is executed for the other display lines in which the display data indicates that the proportion is small.
